(19) United States
(12) Patent Application Publication
(10) Pub. No.: US 2006/0073237 A1
(43) Pub. Date: Apr. 6, 2006

(54) Calcium supplementation of foodstuffs

(75) Inventor: Jamie Goodner, Winter Haven, FL (US)

Correspondence Address: BANNER & WITCOFF, 1001 G STREET N W, SUITE 1100, WASHINGTON, DC, 20001, US

(73) Assignee: Cargill, Inc., Wayzata, MN (US)

(21) Appl. No.: 11/227,435

(22) Filed: Sep. 16, 2005

Related U.S. Application Data
(60) Provisional application No. 60/610,188, filed on Sep. 16, 2004.

(51) Int. Cl. A23L 1/30

(52) U.S. Cl. 426/74

(57) ABSTRACT

Supplementation of foodstuffs with calcium malate, and the resultant products.

### FIELD OF THE INVENTION

The invention relates to the supplementation of foodstuffs with calcium. In particular, the invention relates to the supplementation of acidic foodstuffs with calcium malate.

### BACKGROUND OF THE INVENTION

The RDA (Recommended Daily Allowance) for calcium is 1,200 to 1,500 mg per day. Men age 25 and older, and women age 25 to 50, require 1,000 mg per day. Since less calcium is absorbed as one ages, women older than 50 require closer to 1,500 mg per day. These amounts are recommendations, and many health experts consider the recommended amounts to be inadequate to maintain health.

Recent medical studies have indicated that a diet containing the U.S. recommended daily allowance (“RDA”) of calcium can be effective in preventing or mitigating osteoporosis, and possibly high blood pressure and colon cancer. There is therefore great public interest in the consumption of food products that will supply the recommended daily allowance of calcium.

Typically, a significant reduction in calcium intake occurs in the late-teen years for males, and even earlier for females. Together with the reduced absorption in later years, this early reduction in calcium intake in females may contribute to osteoporosis in post menopausal women.

Calcium can be obtained from a variety of dietary sources. In the United States, the primary sources of calcium are dairy products, in particular milk. Milk provides a very valuable source of dietary calcium. However, beginning in late teenage to young adulthood and continuing through later life, milk is typically not consumed in sufficient quantities by the general population to obtain needed levels of calcium. Additionally, a significant portion of the population becomes lactose intolerant as they reach maturity, resulting in gastrointestinal problems if they consume milk.

To achieve greater consumption of calcium, an alternative to milk is needed. This alternative must be one which is consumed in sufficient quantities to provide nutritionally beneficial amounts of calcium. The general public often consumes fruit juice products, especially orange juice. Like milk, orange juice has a wholesome, nutritional image. Also, orange juice is generally considered to have an appealing taste. Accordingly, orange juice nutritionally supplemented with calcium could be viewed as an additional vehicle for achieving greater dietary calcium intake throughout life.

Calcium supplementation of foodstuffs already has been implemented in diverse products. For example, dairy products such as yogurt and juice products supplemented with calcium in various manners have been proposed, and some products are commercially available.

However, calcium supplementation of foodstuffs is not a straightforward matter of adding calcium or a derivative thereof to a foodstuff. For example, calcium hydroxide and calcium carbonate are available for addition to foodstuffs, and are relatively inexpensive. However, both forms of calcium typically interact with a foodstuff, especially an acidic foodstuff. This interaction typically is deleterious to product appearance, flavor, and presentation. These forms are soluble in aqueous media, but typically will cloud a clear product, such as a clear juice. Other forms of calcium often are not sufficiently soluble. Therefore, it is difficult to introduce a nutritionally significant quantity of calcium to a typical serving of foodstuff without adversely affecting public acceptance of the resultant product.

Complex procedures for adding calcium to foodstuffs have been developed to ameliorate the deleterious effects of calcium and calcium derivatives on product quality. For example, one method utilized with beverages, especially juices, involves use of calcium hydroxide or carbonate in combination with citric acid and malic acid. These three components are combined with sugars, whether sugars from other sources or sugars typically present in the juice beverage, to form a slurry that is added to the beverage. However, this method is unsatisfactory because it is complex and because the slurry product will form a gel if not used within about a day of its manufacture.

Another method for supplementing beverages and beverage concentrates requires addition of solubilized calcium; citric, malic, and phosphoric acid; a flavor component; and sweetener other than a sugar alcohol. This method is complex, as it requires combinations of acids within complex limits and additional components (flavoring and sweetener).

Therefore, there exists a need for a method for supplementing the calcium content of foodstuffs that is simple to implement and does not adversely affect the properties and characteristics of the supplemented foodstuffs.

### BRIEF SUMMARY OF THE INVENTION

The invention relates to calcium supplementation of foodstuffs. In accordance with a method of the invention, calcium malate is added to a foodstuff to supplement the calcium content thereof. In particular, the invention relates to calcium supplementation of fluid foods, including fruit juices and other beverages, by addition of calcium malate, and to foods thus supplemented.

The invention provides a simple method for calcium supplementation of foodstuffs in a manner that has little adverse impact of product properties and characteristics.

### DETAILED DESCRIPTION OF THE INVENTION

The invention is directed to calcium supplementation of foodstuffs by addition of calcium malate. The invention also is directed to a method of introducing a nutritionally significant quantity of calcium into a serving of a foodstuff without adversely affecting the organoleptic properties and characteristics of the supplemented food. Thus, foods supplemented in accordance with the method of the invention provide calcium in a food product that has essentially the same organoleptic properties and characteristics as the unsupplemented food.

The inventors have discovered that because calcium malate has reasonable solubility in aqueous media, it is suited for calcium supplementation of such media. Calcium malate is very slightly soluble in water, about 0.31 g/100 g water at 25° C. Thus, supplementation of water to the solubility limit would provide about 75 mg calcium per 100 g of water.

The solubility of calcium malate in an aqueous medium is enhanced if the medium is acidic, i.e., the pH is between about 3.5 and about 6.5. Many foods and beverages have pH values within and close to this range. Therefore, in accordance with the method of the invention, calcium malate is used to increase the amount of calcium in the food or beverages.

Skilled practitioners recognize that consumers typically will find a beverage unpalatable at a pH below about 3.5. The pHs of fruit juices typically are within the range of about 3.5 to about 5.0. Therefore, fruit juices are suitable for supplementation in accordance with the method of the invention Other foods having a liquid component having a pH at which calcium malate is soluble can be supplemented with calcium in accordance with the method of the invention. The solubility of calcium malate also is enhanced by increasing the temperature of the aqueous medium.

Any foodstuff that comprises an aqueous medium is suitable for supplementation in accordance with the invention. Thus, fluid beverages are particularly suited for supplementation. Fruit and vegetable juices are preferred for calcium supplementation in accordance with the invention. Other foodstuffs, such as yogurt and yogurt drinks, blends of fruit or vegetable juice with milk, coffee, and tea, also are particularly suited. Blends of fruit juices with carbonated fluids now are popular with consumers. Such blends also are suitably supplemented in accordance with the invention.

Flavored and vitamin-supplemented waters and similar beverages also provide an opportunity for application of the method of the invention. Calcium supplementation of such flavored and vitamin-supplemented waters provides the opportunity to increase the calcium intake of persons who consume such products instead of or in addition to water.

Calcium malate exhibits good solubility in acidic fluid. Orange juice is one embodiment of a fruit juice that is acidic. Further, orange juice is enjoyed by many and typically easily tolerated. However, it is essentially devoid of calcium, thus making it desirable to add calcium in a soluble form. Therefore, supplementation of orange juice with calcium malate provides many people with an additional source of calcium in nutritionally significant quantity.

Other fruit and vegetable juices are preferably supplemented in accordance with the method of the invention, particularly in view of the fact that most such juices are acidic. To supplement such juices with calcium is particularly helpful, because most such juices have little, if any, calcium. As used herein, supplementation of fruit and vegetable juices includes supplementation of foodstuffs containing any fraction of juice, such as drinks, juice beverages, and the like.

The solubility of calcium malate increases with increased temperature. However, once the calcium malate is dissolved into a warm aqueous medium, it does not precipitate upon cooling of the medium to ambient temperature. The inventors have discovered that this characteristic makes calcium malate particularly suited for calcium supplementation of fluid beverages, which typically are heated to reduce undesirable biologic activity, then cooled.

The inventors also have discovered that the increased solubility of calcium malate at higher temperature, and its resistance to precipitation upon cooling, makes calcium malate particularly suited for supplementation of beverage concentrates. In particular, the inventors have discovered that beverage concentrates supplemented with calcium in the form of calcium malate in accordance with the invention, when reconstituted to ‘single strength,’ i.e., the strength at which the beverage is consumed, yield a product that has essentially the same organoleptic properties and characteristics as unsupplemented product.

Supplementation with calcium malate in accordance with the invention provides a supplemented foodstuff that has organoleptic properties and characteristics essentially unchanged from unsupplemented foodstuff. Supplementation in accordance with the invention does not adversely affect physical appearance of the product. For example, a clear juice, such as apple juice, remains clear upon supplementation. Further, calcium malate does not introduce carbon dioxide gas into the foodstuff, as calcium carbonate does. Also, because calcium malate has a low flavor profile, the taste of the supplemented product is essentially unchanged from that of the unsupplemented product.

In accordance with the method of the invention, calcium malate is blended into the foodstuff in desired quantity until it is dissolved. Typically, high-energy blending or vigorous agitation typically is not required. Rather, typical low-intensity blending with a paddle or hook mixer, or a similar low-intensity device, is sufficient to ensure that the calcium malate is evenly distributed throughout the fluid. Blending is carried out for a time sufficient to ensure complete dissolution of the calcium malate and even distribution thereof throughout the supplemented food or beverage.

In-line mixing also can be used to introduce and blend calcium malate into the food as it is transported between two other processing steps. The skilled practitioner, with the guidance provided herein, will be able to develop a blending regime that distributes calcium malate evenly in the food or beverage supplemented in accordance with the method of the invention.

Because the solubility of calcium malate increases with increasing temperature, it is possible to dissolve sufficient calcium malate to yield a higher level of supplementation than can be achieved at ambient temperature. Thus, any foodstuff that can be heated can be supplied to a higher-calcium concentration than can be obtained at ambient temperature.

If desired, the heating step can be combined with the heat treatment typically used as part of the packaging process for, for example, beverages. Upon cooling, the calcium malate will remain in solution, even if the beverage is frozen. Indeed, the inventors have found that dissolved calcium malate does not precipitate, even if a beverage concentrate is frozen.

The invention is especially suited for supplementation of fruit juices, including orange juice, apple juice, and pineapple juice. Further, juice concentrates also are especially suited for supplementation in accordance with the invention. For example, orange juice concentrate typically is available as a concentration that is six times that of ‘single strength.’ Such orange juice concentrate is suitably supplemented in accordance with the invention.

The amount of calcium added is sufficient to provide a nutritionally significant amount of calcium per serving of supplemented foodstuff. Thus, calcium malate is added in a quantity sufficient to provide between about 10 and about 1000 mg calcium/100 g food. The exact quantity of calcium added is not critical to practice of the invention. Indeed, the quantity of calcium to be added to a product often is a business decision. Thus, calcium in a wide range of quantities that can be added to the foodstuff that is to be supplemented. Preferably, supplementation is provided at a level sufficient to provide about 20 and about 750 mg calcium per 100 g, and more preferably between about 25 and about 500 mg/g, respectively.

The quantity of calcium that can be introduced is limited only by the solubility of calcium malate in the foodstuff. One embodiment of the invention is to introduce calcium malate in quantity sufficient to provide between about 25 and about 500 mg calcium ion (Ca⁺⁺) per 100 g of single strength orange juice, preferably between about 50 and about 400 mg, more preferably between about 75 and about 300 mg, and most preferably between about 100 and about 200 mg calcium ion per 100 g of single strength orange juice. At this most preferred concentration, a single serving (150-200 g) of orange juice provides between about 150 and about 400 mg calcium. This quantity of calcium is at least about 10% of the RDA for calcium. Thus, a single serving of such supplemented juice prepared in accordance with the method of the invention provides a not insignificant fraction (up to about 40 percent) of the calcium RDA.

Juices concentrated to any degree also can be supplemented in accordance with the method of the invention. Supplementation of orange juice concentrate (6×) is another preferred embodiment of the invention because this concentration is commercially significant. Inasmuch as the concentration of the orange juice is 6 times that of single strength, the amount of calcium malate also increases by a factor of 6 to between about 150 and about 3000 mg calcium ion, preferably between about 300 and about 2400 mg, more preferably between about 450 and about 1800 mg, and most preferably between about 600 and about 1200 mg calcium ion per 100 g 6× orange juice concentrate.

Many other juices typically are sold commercially, whether concentrated or at single strength. Juices thus available include apple, pear, plum, lemon, lime, cranberry, cherry, pineapple, carrot, celery, tomato, grape, and pomegranate juices. Lemonade, limeade, and fruit punches are amongst juices and juice products typically available as frozen concentrates. Each is typically lacking calcium, and so is well suited for calcium supplementation in accordance with the claimed invention. Also, these and other juices, including orange juice, often are used in cooking, and so can be used s a vehicle to supplement calcium in a variety of prepared foods.

With the guidance provided herein, skilled practitioners will be able to identify suitable calcium ion concentrations for other foodstuffs.

The method of making the supplemented product of the invention is straightforward. Calcium malate simply is dissolved into and blended with the foodstuff. Calcium malate typically is available as a solid powder. In accordance with the method of the invention, this powder is dissolved in the foodstuff, typically with blending at any level of agitation appropriate under the circumstances. For example, although only mild, low-intensity blending is necessary, calcium malate can be added at any step requiring stirring or blending at any intensity. In the alternative, calcium malate can be stirred into the foodstuff by an in-line mixer.

The invention obviates the need to acidify an acidic foodstuff in support of the solubility of the calcium ion in the aqueous medium. Thus, addition of, e.g., citric acid is not required to solubilize the calcium-containing compound. Addition of other materials to compatibilize the calcium-containing compound, i.e., to counter any deleterious organoleptic effect or perceptible effect on product quality, such as cloudiness, also is obviated. The invention therefore obviates both the need to add other such materials and their associated deleterious effects on organoleptic properties and characteristics. As a result, the resultant supplemented product is more like the unsupplemented product.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, calcium malate can be added at any blending step, without regard to the type of mixer used. Further, calcium malate can be added at any reasonable temperature, and temperature can be increased to increase the solubility because calcium malate thus dissolved will not precipitate when the product is cooled.

I claim:

1. A foodstuff supplemented with calcium malate.

2. The foodstuff of claim 1 wherein calcium is supplemented in an amount between about 10 and 1000 mg calcium/gram of foodstuff.

3. The foodstuff of claim 2 wherein calcium is supplemented in an amount between about 25 and 500 mg calcium/gram of foodstuff.

4. The foodstuff of claim 1 wherein the foodstuff is selected from the group consisting of fruit juice, vegetable juice, dairy products, milk, yogurt, and blends thereof.

5. The foodstuff of claim 4 wherein the foodstuff is selected from the group consisting of fruit juice, vegetable juice, and blends thereof.

6. The foodstuff of claim 5 wherein the juice is selected from the group consisting of apple, pear, plum, lemon, lime, cranberry, cherry, pineapple, carrot, tomato, celery, grape, orange, and pomegranate juice, and blends thereof.

7. The foodstuff of claim 6 wherein the juice is orange juice.

8. The foodstuff of claim 5 wherein the juice is concentrated.

9. The foodstuff of claim 5 wherein the juice is single strength.

10. The foodstuff of claim 7 wherein the juice is concentrated.

11. The foodstuff of claim 7 wherein the juice is single strength.

12. The foodstuff of claim 1 wherein the foodstuff has a pH of between about 3.5 and about 6.5.

13. The foodstuff of claim 12 wherein the foodstuff has a pH of between about 3.5 and about 5.

14. A method for supplementing the calcium concentration in a foodstuff comprising an aqueous medium, the method comprising dissolving calcium malate in the foodstuff.

15. The method of claim 14 further comprising agitating the foodstuff containing the calcium malate until the calcium malate is dissolved.

16. The method of claim 15 wherein the agitation is low-intensity agitation.

17. The method of claim 16 wherein the agitation is part of another processing step.

18. The method of claim 15 further comprising heating the foodstuff during agitation.

19. The method of claim 18 wherein the heating is part of another processing step.
